(19) United States
(12) Patent Application Publication
(10) Pub. No.: US 2026/0366351 A1
(43) Pub. Date: Nov. 19, 2026

(54) EMERGENCY PASSAGE FUNCTION INDICATOR ASSEMBLY

(71) Applicant: B/E Aerospace, Inc., Winston-Salem, NC (US)

(72) Inventors: Mark A. Elliott, Winston-Salem, NC (US); Mark A. Vanhoy, Hamptonville, NC (US)

(21) Appl. No.: 19/668,460

(22) Filed: May 5, 2026

Related U.S. Application Data
(60) Provisional application No. 63/805,702, filed on May 14, 2025.

(51) Int. Cl. E05D 15/10; B64C 1/14; B64D 45/00

(52) U.S. Cl. CPC E05D 15/1047; B64C 1/1461; B64D 45/00; E05D 2015/106; E05Y 2201/64; E05Y 2900/502; E05Y 2900/531

(57) ABSTRACT

A sliding door assembly includes a door and a carriage coupled to the door. A rail assembly guides the door and is configured to operate in a functioning door condition and a malfunction condition in which a first portion of the rail assembly inhibits translation of the carriage and a second portion of the rail assembly permits movement of the door relative to the carriage. An indicator assembly includes a stationary structure defining a window, an elongated member pivotally coupled to the stationary structure, and an indicator carried by the elongated member and viewable through the window. A roller subassembly coupled to the door engages a ramp feature associated with the carriage to maintain the elongated member in a first position corresponding to the functioning door condition and disengages from the ramp feature in the malfunction condition to pivot the elongated member to a second position.

### CROSS-REFERENCE TO RELATED APPLICATION

This nonprovisional application claims the benefit of priority of U.S. Provisional Application No. 63/805,702 filed May 14, 2025, which is hereby incorporated by reference in its entirety.

### TECHNICAL FIELD

The present disclosure relates generally to aircraft interior sliding doors, and more particularly, to a sliding door assembly including an emergency passage function (EPF) indicator assembly for alerting the cabin crew to an improperly functioning sliding door.

### BACKGROUND

Sliding doors are commonly used in aircraft interiors, including in passenger suites and mini-suites, as well as in closets, wardrobes, and similar compartments. Sliding doors can be preferable to hinged doors in these applications because they reduce clearance requirements and allow efficient use of limited cabin space.

Aircraft safety standards generally require that such sliding doors include an emergency passage function (EPF) that enables egress if the door becomes jammed or otherwise fails to operate normally. Existing EPF solutions often rely on frangible or removable door portions, detachable panels, or redundant rail and track arrangements intended to allow the door to be moved or removed under emergency conditions. While these approaches can be effective, they may add cost, weight, and mechanical complexity to the door system.

Safety standards also require that sliding door systems include an indicator to inform the flight crew when an EPF condition is active, such as when an emergency release has been triggered or an emergency panel has been displaced. Conventional indicator solutions typically mount the indicator directly on the sliding door. Because the door moves between open and closed positions, the indicator must also move with the door.

In some aircraft installations, however, placing the indicator on the moving door is undesirable. A door-mounted indicator can complicate the door mechanism, require additional wiring or moving connections, and increase the likelihood of wear or failure over time. It may also interfere with design constraints in areas where the door travels close to surrounding structures.

Accordingly, there is a need for improved EPF indicator arrangements for aircraft sliding doors. In particular, there is a need for an EPF indicator that can be positioned away from the moving door, such as on a fixed surface near the door, while still providing a clear indication to the flight crew that an EPF condition is active.

### SUMMARY

According to one aspect, a sliding door assembly is disclosed in accordance with one or more illustrative embodiments of the present disclosure. In embodiments, the sliding door assembly includes a door movable between an open position and a closed position, a carriage coupled to the door, a rail assembly operably associated with the carriage and configured to guide sliding movement of the door, the rail assembly configured to operate in a functioning door condition and a malfunction condition in which a first portion of the rail assembly is configured to inhibit translation of the carriage and a second portion of the rail assembly is configured to permit movement of the door relative to the carriage, a stationary structure positioned adjacent the door and defining a window, an elongated member pivotally coupled to the stationary structure, an indicator carried by the elongated member and viewable through the window, a roller subassembly coupled to the door, and a ramp feature associated with the carriage. In use, roller subassembly is configured to engage the ramp feature to maintain the elongated member in a first position in which the indicator provides a first indication through the window corresponding to the functioning door condition, and the roller subassembly is configured to disengage from the ramp feature to permit the roller subassembly to engage the elongated member and pivot the elongated member to a second position in which the indicator provides a second indication through the window corresponding to the malfunction condition.

In some embodiments, the rail assembly includes a primary rail and a secondary rail each coupled to the carriage such that, when the door is operating in the functioning door condition, the carriage translates relative to the primary rail and is fixed relative to the secondary rail, and when the door is operating in the malfunction condition, the carriage is fixed relative to the primary rail and the secondary rail is configured to translate relative to the carriage to allow the door to be moved to a stowed condition.

In some embodiments, the ramp feature is inclined and formed on or carried by the carriage.

In some embodiments, the roller subassembly is pivotally coupled to the door and comprises a bearing configured to roll along the ramp feature.

In some embodiments, the assembly further includes a spring configured to bias the roller subassembly toward the elongated member.

In some embodiments, the elongated member is pivotally coupled to the stationary structure at a first end portion of the elongated member and at a second end portion of the elongated member.

In some embodiments, the assembly further includes a spring configured to bias the elongated member toward the second position.

In some embodiments, the roller subassembly is configured to engage the elongated member at any of a plurality of locations along a length of the elongated member.

In some embodiments, the indicator is positioned at a first end portion of the elongated member.

In some embodiments, the first indication and the second indication are each color coded.

According to another aspect, an emergency passage function (EPF) indicator assembly for a sliding door assembly is disclosed in accordance with one or more illustrative embodiments of the present disclosure. In embodiments, the EPF indicator assembly includes a stationary structure defining a window, an elongated member pivotally coupled to the stationary structure, an indicator carried by the elongated member and viewable through the window, and a roller subassembly configured to be coupled to a door. In use, the roller subassembly is configured to engage an inclined ramp feature associated with a carriage of the sliding door assembly to maintain the elongated member in a first position in which the indicator provides a first indication through the window corresponding to a functioning door condition, and the roller subassembly is configured to disengage from the ramp feature to permit the roller subassembly to engage the elongated member and pivot the elongated member to a second position in which the indicator provides a second indication through the window corresponding to a malfunction condition.

According to a further aspect, a method of indicating an emergency passage function (EPF) condition in a sliding door assembly is disclosed in accordance with one or more illustrative embodiments of the present disclosure. In embodiments, the method includes providing a door movable between an open position and a closed position, providing a carriage coupled to the door, the carriage operably associated with a primary rail and a secondary rail, providing a stationary structure adjacent the door, the stationary structure defining a window, providing an elongated member pivotally coupled to the stationary structure, the elongated member carrying an indicator viewable through the window, coupling a roller subassembly to the door, during a normal functioning condition of the sliding door assembly, maintaining the roller subassembly in engagement with a ramp feature associated with the carriage to maintain the elongated member in a first position in which the indicator provides a first indication through the window, and upon occurrence of a malfunction condition of the sliding door assembly, disengaging the roller subassembly from the ramp feature, engaging the roller subassembly with the elongated member, and pivoting the elongated member to a second position in which the indicator provides a second indication through the window.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a portion of a sliding door assembly including an EPF indicator assembly shown in an inactive condition, in accordance with example embodiments of this disclosure.

FIG. 2 illustrates the inactive condition of a roller mechanism of the indicator assembly, in accordance with example embodiments of this disclosure.

FIG. 3 illustrates the EPF indicator in the inactive condition presenting a corresponding ‘green’ color, in accordance with example embodiments of this disclosure.

FIG. 4 illustrates a portion of the sliding door assembly including the EPF indicator assembly shown indicating an active condition, in accordance with example embodiments of this disclosure.

FIG. 5 illustrates the active condition of the roller mechanism of the indicator assembly, in accordance with example embodiments of this disclosure.

FIG. 6 illustrates the EPF indicator in the active condition presenting a corresponding ‘red’ color, in accordance with example embodiments of this disclosure.

FIG. 7 illustrates the EPF indicator assembly removed from the door assembly, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, the present disclosure relates to an operating condition indication arrangement for a sliding door assembly used in aircraft interiors, such as suite and mini-suite doors, wardrobe doors, and similar enclosures. In such environments, safety guidelines require that the door remain operable for egress even if a component of the door guidance mechanism fails, and further require a clear indication to the cabin crew when a malfunction condition exists so it can be serviced or otherwise attended to.

In embodiments, the sliding door assembly includes a door movable between open and closed positions, and a carriage coupled to the door. A rail assembly guides the sliding movement of the door and is configured to operate in both a functioning door condition and a malfunction condition. In the malfunction condition, a first portion of the rail assembly inhibits translation of the carriage, while a second portion of the rail assembly permits movement of the door relative to the carriage to allow the door to be moved out of the way (e.g., stowed) for egress.

The door assembly further includes an indicator assembly configured to provide a visible malfunction indication from a stationary location adjacent the door. In embodiments, the indicator assembly includes a stationary structure defining a window, an elongated member pivotally coupled to the stationary structure, and an indicator carried by the elongated member and visible through the window. A roller subassembly coupled to the door interacts with a ramp feature associated with the carriage to maintain the indicator in a first position during normal operation (i.e., functioning door condition), and to shift the indicator to a second position upon occurrence of the malfunction condition. In this manner, the indicator provides a clear visual signal of door malfunction status while avoiding the need to mount the indicator directly on the moving door.

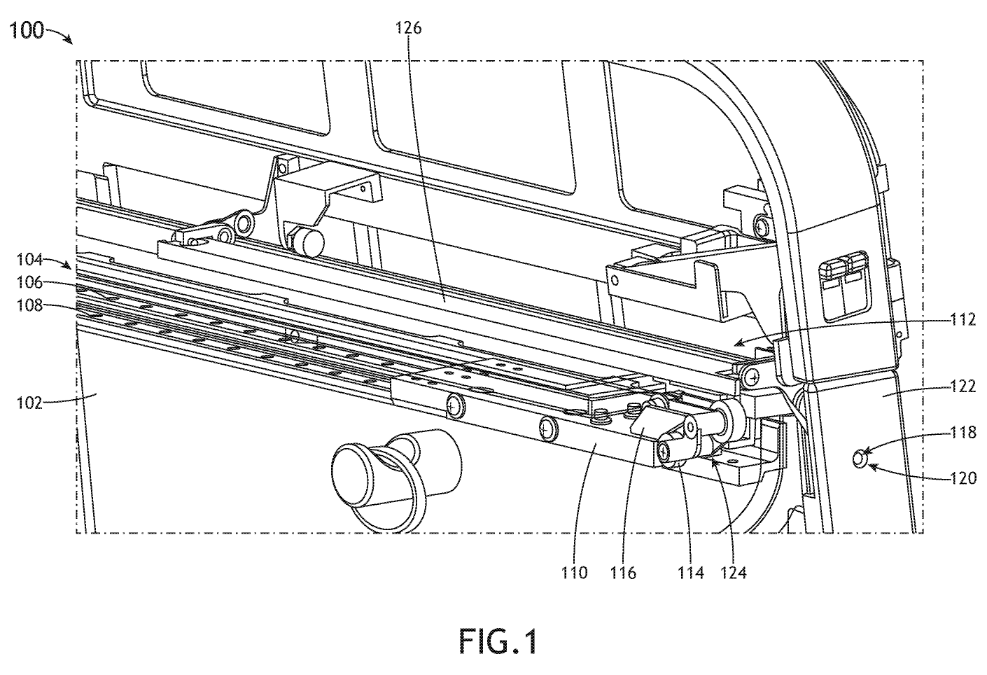

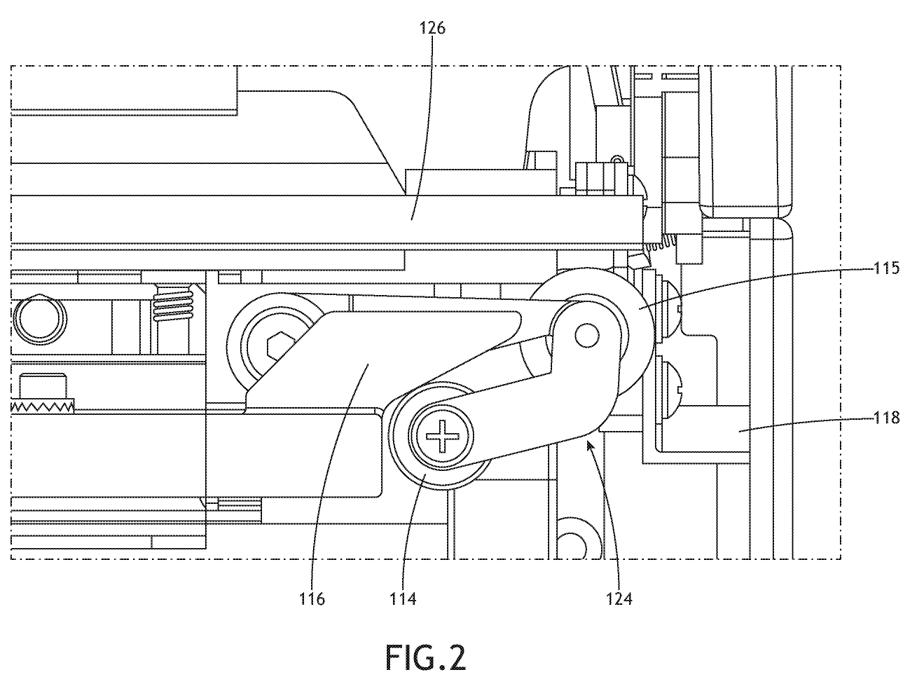

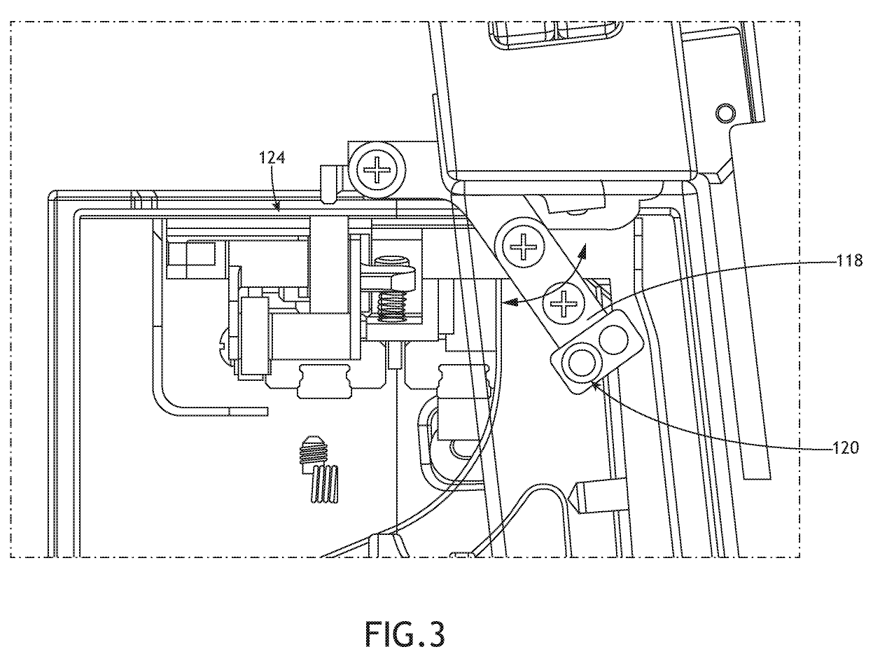

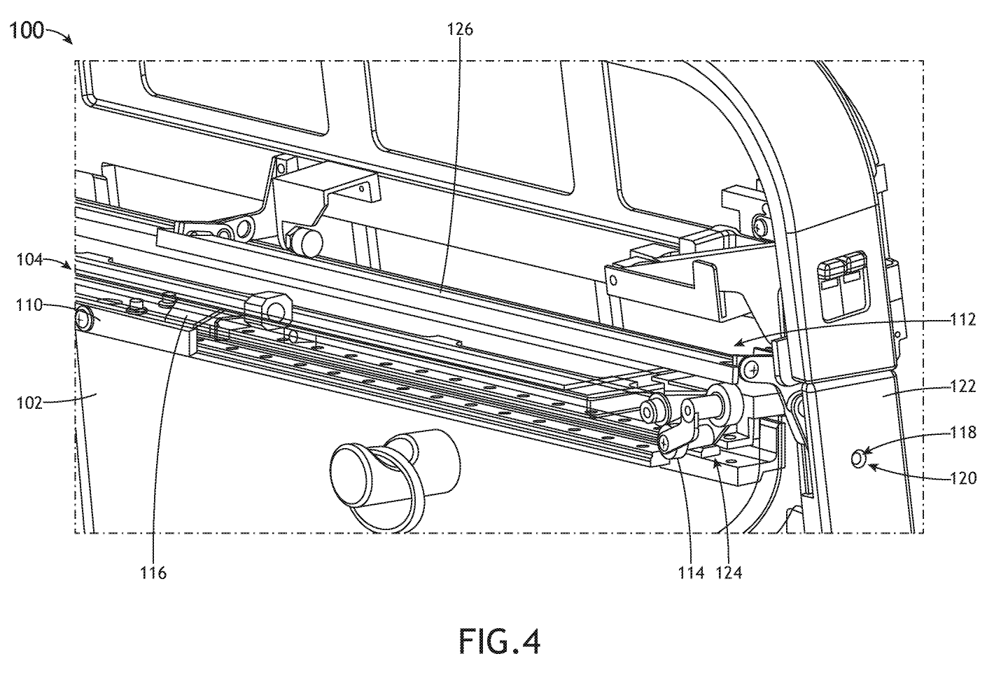

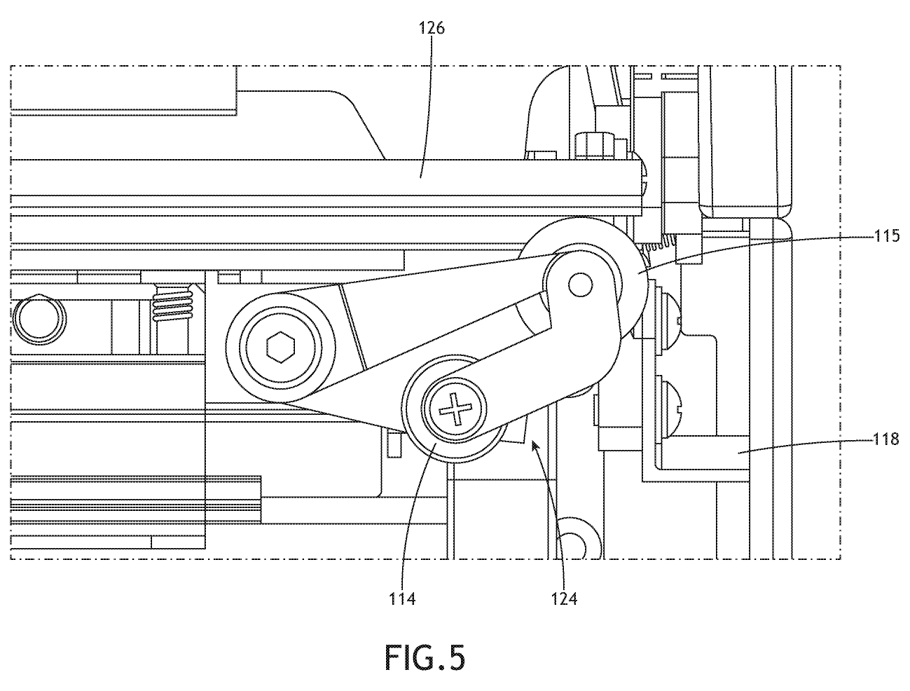

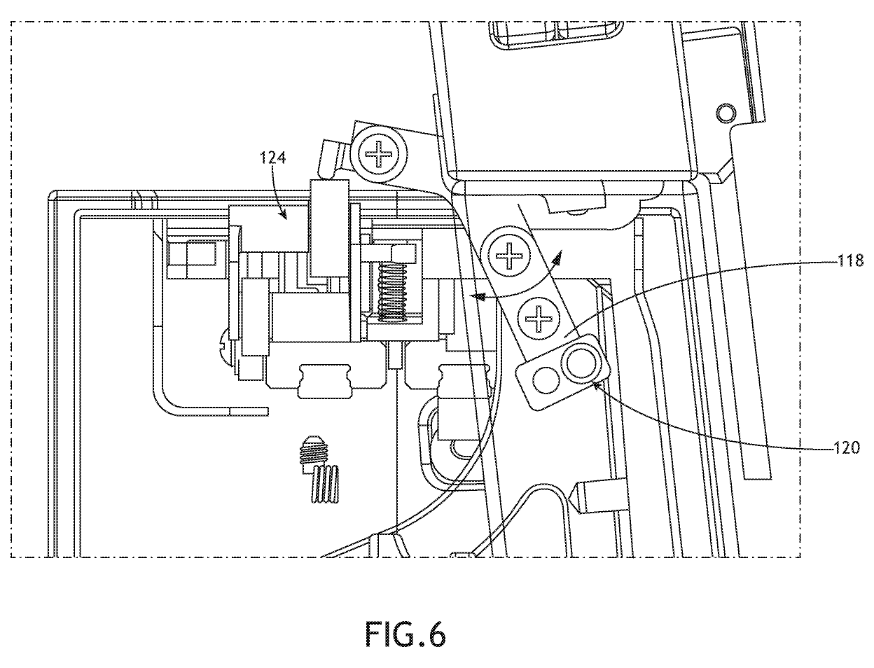

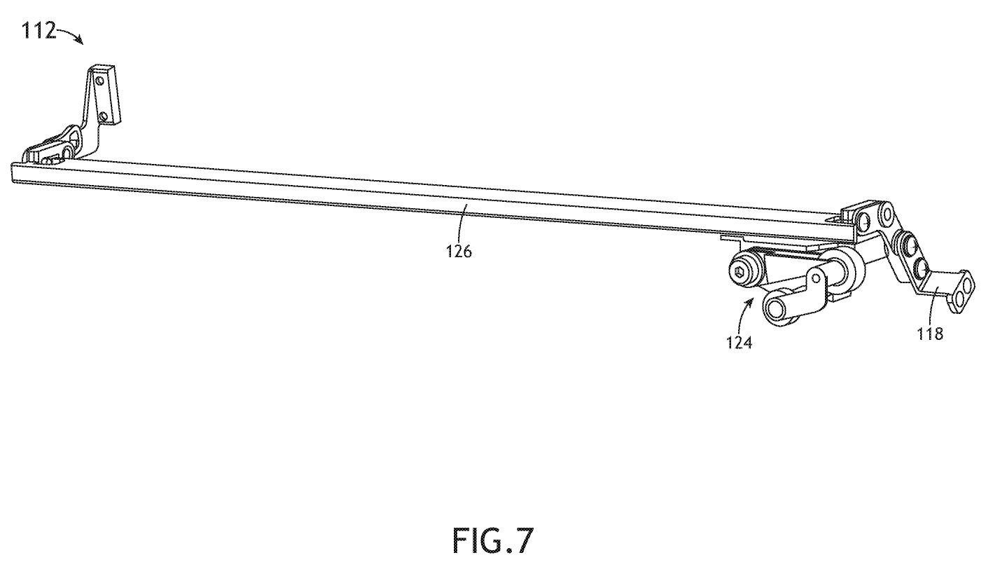

The figures illustrate a sliding door assembly 100 configured for use in an aircraft interior environment, such as within a passenger suite or mini-suite, closet, wardrobe, or other enclosure where space constraints and safety requirements make sliding door systems desirable. FIGS. 1-3 illustrate the sliding door assembly 100 operating in a functioning door condition. FIGS. 4-6 illustrate the sliding door assembly 100 operating in a malfunction condition. FIG. 7 illustrates the indicator assembly 112 and the disposition of the roller/bearing subassembly 124 relative to the elongated rail 126.

In the illustrated embodiment, the sliding door assembly 100 includes a sliding door 102 movable between an open position and a closed position. The door 102 may be configured to selectively obstruct or permit access through an opening, passageway, or compartment entrance, and may be deployed and stowed through linear sliding movement. In some embodiments, the door 102 may be a wardrobe door, a suite door, or other cabin door configured for passenger privacy or compartment access.

In embodiments, the sliding door assembly 100 includes at least one rail assembly 104 configured to guide the sliding movement of the door 102 between its open and closed positions. The at least one rail assembly 104 may be positioned at an upper region of the door 102, a lower region of the door 102, or both. In some embodiments, the sliding door assembly 100 may include an upper rail assembly and a lower rail assembly, which may be alike or substantially similar in construction.

In embodiments, each rail assembly 104 may be a redundant assembly generally including a primary rail 106 and a secondary rail 108 each coupled to a carriage 110. When the door 102 is operating in the functioning door condition (i.e., normal use, non-EPF condition, absence of a rail malfunction, etc.), the carriage 110 translates relative to the primary rail 106 and is fixed relative to the secondary rail 108. When the door 102 is operating in the malfunction condition (i.e., EPF condition, primary rail 106 malfunction), the carriage 110 is fixed relative to the primary rail 106 and the secondary rail 108 translates relative to the carriage 110 to allow the door 102 to be moved to a stowed condition for egress (e.g., not blocking a passageway). Thus, the rail assembly 104 is operably associated with the carriage 110 coupled to the door 102 such that the carriage 110 is configured to translate along the rail assembly 104 during normal operation. In embodiments, the carriage 110 may include rollers, bearings, sliders, or other features configured to interface with the rail assembly 104 to permit smooth linear translation.

The rail assembly 104 is configured to operate in at least two operating modes or conditions, including a functioning door condition and a malfunction condition. In the functioning door condition, the rail assembly 104 permits translation of the carriage 110 such that the door 102 may be moved between the open and closed positions in a normal manner. In the malfunction condition, a first portion of the rail assembly 104 inhibits translation of the carriage 110, such as due to a jam, failure, misalignment, breakage, or other malfunction associated with a rail component. In such a malfunction condition, a second portion of the rail assembly 104 is configured to permit movement of the door 102 relative to the carriage 110 so that the door 102 can still be moved to a stowed position. In this manner, the rail assembly 104 provides a redundant movement capability if a component of the rail assembly 104 malfunctions or becomes inoperable.

The sliding door assembly 100 further includes an indicator assembly 112 configured to provide a visible indication of whether the sliding door assembly 100 is operating in the functioning door condition or the malfunction condition. In embodiments, the indicator assembly 112 is configured to provide a malfunction indication associated with an active EPF condition. The indicator assembly 112 may be configured to provide a clear visual cue to cabin crew, maintenance personnel, or other observers that the sliding door assembly 100 has transitioned into a malfunction state requiring attention. In contrast to conventional indicator solutions that are mounted directly on a moving door, the indicator assembly 112 of the present disclosure is configured to be mounted on a stationary structure adjacent the door 102, thereby avoiding the need for the indicator to translate with the door 102 as it slides between its open and closed positions.

In embodiments, the sliding door assembly 100 includes a stationary structure 122 positioned adjacent the door 102. The stationary structure 122 may comprise a fixed aircraft interior wall, bulkhead surface, partition, or other static surface positioned proximal to the sliding travel path of the door 102. The stationary structure 122 defines a window 120 through which an indicator 118 associated with the indicator assembly 112 may be viewed. The window 120 may be positioned on an end or forward-facing portion of the stationary structure 122 or otherwise positioned such that the indicator 118 is visible to the cabin crew when the door sliding door assembly 100 is installed within the aircraft cabin. In some embodiments, the window 120 may comprise an aperture, cutout, or similar viewing feature.

In embodiments, the indicator assembly 112 includes an elongated member 126 pivotally coupled to the stationary structure 122. The elongated member 126 may comprise a rail, lever, bar, rod, or other elongated component configured to pivot about one or more pivot connections. In some embodiments, the elongated member 126 is pivotally mounted at its opposing ends to the stationary structure 122, such as by a first pivot connection at a first end portion and a second pivot connection at a second end portion. The elongated member 126 may be configured to pivot between a first position as shown in FIGS. 1-3, and a second position as shown in FIGS. 4-6, wherein the first position corresponds to the functioning door condition, and the second position corresponds to the malfunction condition. In embodiments, the elongated member 126 may be spring biased, such as by a spring or resilient element, toward one of the first position or the second position. For example, the elongated member 126 may be biased downward or upward depending on the installation orientation and desired indicator motion.

In embodiments, the indicator assembly 112 includes the indicator 118 carried by the elongated member 126. The indicator 118 may be positioned at an end portion of the elongated member 126, such as at a forward end portion that aligns with the window 120. The indicator 118 includes indicia corresponding to different door conditions. For example, the indicator 118 may include first indicia corresponding to the functioning door condition and second indicia corresponding to the malfunction condition. In one example, the indicia may be color coded, for instance the first indicia may comprise green indicia and the second indicia may comprise red indicia, such that the indicator 118 displays green through the window 120 to indicate the functioning door condition and red to indicate the malfunction condition. In other embodiments, the indicia may comprise symbols, text, patterns, shapes, or other markings suitable for conveying a condition to a viewer. In alternative embodiments, the indication may be electronic, for instance an illuminated and/or audible indicator.

In embodiments, the indicator assembly 112 interfaces with the door 102 via a roller subassembly 124 coupled to the door 102. The roller subassembly 124 may be mounted to the door 102 at a location that moves with the door 102 along the travel path. In embodiments, the roller subassembly 124 includes a roller or bearing 114 configured to contact and roll along a surface of a ramp feature 116 associated with the carriage 110. The roller subassembly 124 may be pivotally coupled to the door 102 such that the roller subassembly 124 is capable of pivoting between a lowered position and a raised position. In some embodiments, the roller subassembly 124 may be biased by a spring toward the raised position, such that the roller subassembly 124 tends to pivot upward unless restrained by engagement with the ramp feature 116. The roller or bearing 114 may comprise a rotatable wheel, roller, ball bearing element, or similar rolling contact element configured to reduce friction and wear during engagement with the ramp feature 116.

In embodiments, the ramp feature 116 is associated with the carriage 110 and may be formed on the carriage 110 or carried by the carriage 110 as a separate component. The ramp feature 116 may be inclined, sloped, or ramped such that engagement between the roller or bearing 114 and the ramp feature 116 applies a force to the roller subassembly 124 tending to pivot the roller subassembly 124 downward and away from the elongated member 126. In this manner, when the roller or bearing 114 is engaged with the ramp feature 116, the roller subassembly 124 may be maintained in a lowered position, thereby preventing contact between the roller subassembly 124 and the elongated member 126.

During operation of the sliding door assembly 100 in the functioning door condition, the carriage 110 translates along the rail assembly 104 as the door 102 is moved between its open and closed positions. In this functioning door condition, the roller or bearing 114 remains in contact with the ramp feature 116 as the carriage 110 translates. The ramp feature 116 thereby maintains the roller subassembly 124 in the lowered position, which in turn maintains the elongated member 126 in the first position. When the elongated member 126 is maintained in the first position, the indicator 118 is positioned such that the first indicia (e.g., green indicia) is visible through the window 120, thereby providing a visual indication that the sliding door assembly 100 is functioning normally.

In the event that the sliding door assembly 100 enters the malfunction condition, such as due to a malfunction of a portion of the rail assembly 104 that inhibits translation of the carriage 110, the carriage 110 may become fixed or restrained relative to the rail assembly 104. In this malfunction condition, the rail assembly 104 is configured such that a second portion of the rail assembly 104 permits movement of the door 102 relative to the carriage 110, allowing the door 102 to be moved to a stowed or open position for passenger egress. As the door 102 moves relative to the carriage 110, the roller subassembly 124 may become disengaged from the ramp feature 116. When the roller or bearing 114 disengages from the ramp feature 116, the roller subassembly 124 is permitted to pivot upward under spring bias. As the roller subassembly 124 pivots upward, the roller or bearing 114 moves into contact with the elongated member 126.

In embodiments, upon engagement between the roller subassembly 124 and the elongated member 126, the roller subassembly 124 applies a force to the elongated member 126, via a roller or bearing 115, causing the elongated member 126 to pivot from the first position toward the second position. The elongated member 126 may pivot upward, downward, or laterally depending on the mounting orientation. As the elongated member 126 pivots to the second position, the indicator 118 is moved such that the second indicia (e.g., red indicia) becomes visible through the window 120. The display of the second indicia through the window 120 provides a visible indication that the sliding door assembly 100 is in the malfunction condition and may require servicing, inspection, or corrective action.

In embodiments, the elongated member 126 is configured such that the roller subassembly 124 can engage the elongated member 126 at any of a plurality of locations (e.g., continuously) along a length of the elongated member 126. In this manner, the indicator assembly 112 may be configured such that the malfunction indication can be triggered regardless of the position of the door 102 along its travel path. For example, even if the door 102 is partially open, partially closed, or located at any intermediate position, disengagement of the roller subassembly 124 from the ramp feature 116 may permit engagement with the elongated member 126, thereby causing the indicator 118 to move to the second position. This configuration allows the indicator assembly 112 to provide reliable malfunction indication without requiring precise alignment between the door 102 and the indicator 118 at a particular door location.

In embodiments, the indicator assembly 112 may be configured such that the indicator 118 remains fixed relative to the stationary structure 122 during normal sliding movement of the door 102 and does not translate with the door 102. Because the indicator 118 is carried by the elongated member 126 mounted to the stationary structure 122, the indicator 118 may be positioned at a fixed location that is consistently visible through the window 120. This arrangement avoids the need for wiring, cabling, or other moving connections associated with door-mounted indicators and further reduces mechanical complexity by isolating the visible indicator portion from the moving door.

In embodiments, the ramp feature 116 is configured such that when the rail assembly 104 is serviced and the sliding door assembly 100 returns to the functioning door condition, the ramp feature 116 may be reengaged with the roller or bearing 114. The ramp feature 116 may be inclined such that reengagement drives the roller subassembly 124 downward and away from the elongated member 126, thereby permitting the elongated member 126 to return to the first position. Upon return of the elongated member 126 to the first position, the indicator 118 returns to display the first indicia through the window 120, thereby indicating that the sliding door assembly 100 is again operating in the functioning door condition. In this manner, the indicator assembly 112 may automatically reset based on reestablishment of engagement between the roller subassembly 124 and the ramp feature 116, without requiring manual repositioning of the indicator 118.

In some embodiments, the roller subassembly 124 may include one or more structural components configured to support the rollers or bearings 114,115 such as brackets, arms, pivots, pins, bushings, or similar hardware. Likewise, the elongated member 126 may include structural features configured to receive engagement from the roller subassembly 124 and transmit pivoting motion to the indicator 118. In some embodiments, the indicator assembly 112 may be enclosed or shielded to prevent interference from debris or incidental contact, while still permitting the indicator 118 to be visible through the window 120.

In embodiments, the sliding door assembly 100 may be installed in an aircraft interior such that the stationary structure 122 comprises a fixed partition wall adjacent the door opening. The window 120 may be positioned on an outward-facing portion of the stationary structure 122 so that the indicator 118 is visible to flight crew members during routine cabin checks. The indicator 118 may thereby provide a quick visual indication of whether the door assembly 100 is operating normally or has transitioned into a malfunction condition associated with an EPF state.

While the described embodiments illustrate the door assembly 100 as a wardrobe door arrangement, it will be understood that the door assembly 100 and indicator assembly 112 may be applied to other aircraft sliding doors including suite doors, mini-suite doors, lavatory doors, storage compartment doors, and other sliding door installations requiring a malfunction indication visible from a stationary location. Further, while the indicator 118 is described as including colored indicia, other visible indicators may be used, including symbols, text markings, or other high-contrast visual features. Additionally, while the roller subassembly 124 is described as including a bearing 114, other contact features may be used to interact with the ramp feature 116 and elongated member 126, including low-friction pads, rollers of different shapes, cam followers, or sliding engagement members.

Accordingly, the sliding door assembly 100 described herein provides a robust solution for indicating a malfunction condition of a sliding door rail assembly while positioning the visible indicator 118 on a stationary structure 122 rather than on the moving door 102. The interaction between the roller subassembly 124, the ramp feature 116, and the elongated member 126 provides automatic transition of the indicator 118 between a first position indicating a functioning door condition and a second position indicating a malfunction condition, thereby providing improved safety visibility and reduced system complexity as compared to conventional door-mounted indicator solutions.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A sliding door assembly, comprising:
a door movable between an open position and a closed position;
a carriage coupled to the door;
a rail assembly operably associated with the carriage and configured to guide sliding movement of the door, the rail assembly configured to operate in a functioning door condition and a malfunction condition in which a first portion of the rail assembly is configured to inhibit translation of the carriage and a second portion of the rail assembly is configured to permit movement of the door relative to the carriage;
a stationary structure positioned adjacent the door, the stationary structure defining a window;
an elongated member pivotally coupled to the stationary structure;
an indicator carried by the elongated member and viewable through the window;
a roller subassembly coupled to the door; and
a ramp feature associated with the carriage;
wherein the roller subassembly is configured to engage the ramp feature to maintain the elongated member in a first position in which the indicator provides a first indication through the window corresponding to the functioning door condition, and
wherein the roller subassembly is configured to disengage from the ramp feature to permit the roller subassembly to engage the elongated member and pivot the elongated member to a second position in which the indicator provides a second indication through the window corresponding to the malfunction condition.

2. The sliding door assembly of claim 1, wherein:
the rail assembly comprises a primary rail and a secondary rail each coupled to the carriage,
when the door is operating in the functioning door condition, the carriage translates relative to the primary rail and is fixed relative to the secondary rail, and
when the door is operating in the malfunction condition, the carriage is fixed relative to the primary rail and the secondary rail is configured to translate relative to the carriage to allow the door to be moved to a stowed condition.

3. The sliding door assembly of claim 1, wherein the ramp feature is inclined and formed on or carried by the carriage.

4. The sliding door assembly of claim 1, wherein the roller subassembly is pivotally coupled to the door and comprises a bearing configured to roll along the ramp feature.

5. The sliding door assembly of claim 1, further comprising a spring configured to bias the roller subassembly toward the elongated member.

6. The sliding door assembly of claim 1, wherein the elongated member is pivotally coupled to the stationary structure at a first end portion of the elongated member and at a second end portion of the elongated member.

7. The sliding door assembly of claim 1, further comprising a spring configured to bias the elongated member toward the second position.

8. The sliding door assembly of claim 1, wherein the roller subassembly is configured to engage the elongated member at any of a plurality of locations along a length of the elongated member.

9. The sliding door assembly of claim 1, wherein the indicator is positioned at a first end portion of the elongated member.

10. The sliding door assembly of claim 1, wherein the first indication and the second indication are each color coded.

11. An emergency passage function (EPF) indicator assembly for a sliding door assembly, comprising:
a stationary structure defining a window;
an elongated member pivotally coupled to the stationary structure;
an indicator carried by the elongated member and viewable through the window; and
a roller subassembly configured to be coupled to a door;
wherein the roller subassembly is configured to engage an inclined ramp feature associated with a carriage of the sliding door assembly to maintain the elongated member in a first position in which the indicator provides a first indication through the window corresponding to a functioning door condition, and
wherein the roller subassembly is configured to disengage from the ramp feature to permit the roller subassembly to engage the elongated member and pivot the elongated member to a second position in which the indicator provides a second indication through the window corresponding to a malfunction condition.

12. The EPF indicator assembly of claim 11, wherein the roller subassembly includes a bearing and is pivotally mountable to the door.

13. The EPF indicator assembly of claim 11, further comprising a spring configured to bias the roller subassembly toward engagement with the elongated member.

14. The EPF indicator assembly of claim 11, wherein the elongated member is pivotally coupled to the stationary structure at a first end portion of the elongated member and at a second end portion of the elongated member.

15. The EPF indicator assembly of claim 11, further comprising a spring configured to bias the elongated member toward the second position.

16. The EPF indicator assembly of claim 11, wherein the roller subassembly is configured to engage the elongated member at any of a plurality of locations along a length of the elongated member.

17. A method of indicating an emergency passage function (EPF) condition in a sliding door assembly, the method comprising:
providing a door movable between an open position and a closed position;
providing a carriage coupled to the door, the carriage operably associated with a primary rail and a secondary rail;
providing a stationary structure adjacent the door, the stationary structure defining a window;
providing an elongated member pivotally coupled to the stationary structure, the elongated member carrying an indicator viewable through the window;
coupling a roller subassembly to the door;
during a normal functioning condition of the sliding door assembly, maintaining the roller subassembly in engagement with a ramp feature associated with the carriage to maintain the elongated member in a first position in which the indicator provides a first indication through the window;
upon occurrence of a malfunction condition of the sliding door assembly, disengaging the roller subassembly from the ramp feature, engaging the roller subassembly with the elongated member, and pivoting the elongated member to a second position in which the indicator provides a second indication through the window.

18. The method of claim 17, further comprising reengaging the roller subassembly with the ramp feature to return the elongated member to the first position.

19. The method of claim 17, wherein engaging the roller subassembly with the elongated member comprises engaging the roller subassembly with the elongated member at one of a plurality of locations along a length of the elongated member.

20. The method of claim 17, further comprising biasing the roller subassembly toward the elongated member using a first spring, and biasing the elongated member toward the second position using a second spring.
